(19) United States
(12) Patent Application Publication
(10) Pub. No.: US 2008/0208683 A1
(43) Pub. Date: Aug. 28, 2008

(54) PROVIDING PREFERRED TREATMENT BASED ON PREFERRED CONDUCT

(76) Inventors: Christopher J. Dawson, Arlington, VA (US); Rick A. Hamilton, Charlottesville, VA (US); Clifford A. Pickover, Yorktown Heights, NY (US); James W. Seaman, Falls Church, VA (US)

Correspondence Address: HOFFMAN WARNICK LLC, 75 STATE ST, 14TH FLOOR, ALBANY, NY, 12207, US

(21) Appl. No.: 11/679,453

(22) Filed: Feb. 27, 2007

(51) Int. Cl. G06Q 30/00

(52) U.S. Cl. 705/14

(57) ABSTRACT

A method, system and computer program product for encouraging a virtual world user to perform a conduct are disclosed. According an embodiment, a method for encouraging a virtual world user to perform a conduct comprises: monitoring the virtual world user with respect to the conduct; and providing an infrastructural treatment to the virtual world user based on an amount of the conduct performed by the virtual world user.

### FILED OF THE INVENTION

The present disclosure relates in general to a virtual world, and more particularly to encouraging a virtual world user to perform a preferred conduct.

### BACKGROUND OF THE INVENTION

Virtual worlds represent the latest technological forefront and present a tremendous new outlet for both structured and unstructured virtual collaboration, virtual gaming and exploration, and real-life simulation in virtual world spaces. A virtual world is a computer-based simulated environment for a user to participate via a virtual representation, referred to as an “avatar”. In a virtual world, e.g., SECOND LIFE® owned by Linden Lab, a virtual world user is provided with tools to view, navigate, and modify the virtual world space and participate in its virtual activities. These virtual activities, along with various yet to be created new dimensions, provide a wide open arena for creative and new advertising methods and mechanisms.

### SUMMARY OF THE INVENTION

A first aspect of the invention is directed to a method for encouraging a virtual world user to perform a conduct, the method comprising: monitoring the virtual world user with respect to the conduct; and providing an infrastructural treatment to the virtual world user based on an amount of the conduct performed by the virtual world user.

A second aspect of the invention is directed to a system for encouraging a virtual world user to perform a conduct, the system comprising: means for monitoring the virtual world user with respect to the conduct; and means for providing an infrastructural treatment to the virtual world user based on an amount of the conduct performed by the virtual world user.

A third aspect of the invention is directed to a computer program product comprising: computer usable program code which, when executed by a computer system, enables the computer system to: receive data regarding a monitored performance of a virtual world user with respect to a conduct; and determine an infrastructural treatment to the virtual world user based on an amount of the conduct performed by the virtual world user.

A fourth aspect of the invention is directed to a method for deploying a system for encouraging a virtual world user to perform a conduct, comprising: providing a computer infrastructure being operable to: receive data regarding a monitored performance of the virtual world user with respect to the conduct; and determine an infrastructural treatment to the virtual world user based on an amount of the conduct performed by the virtual world user.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE DRAWINGS

The embodiments of this disclosure will be described in detail, with reference to the following figures, wherein like designations denote like elements, and wherein:

FIG. 1 shows a block diagram of a system according to an embodiment of the invention.

FIG. 2 shows a block diagram of an illustrative computer environment according to an embodiment of the invention.

FIG. 3 shows an embodiment of the operation of a treatment awarding system.

It is noted that the drawings of the disclosure are not to scale. The drawings are intended to depict only typical aspects of the disclosure, and therefore should not be considered as limiting the scope of the invention. In the drawings, like numbering represents like elements among the drawings.

### DETAILED DESCRIPTION OF THE DISCLOSURE

The following detailed description of embodiments refers to the accompanying drawings, which illustrate specific embodiments of the disclosure. Other embodiments having different structures and operations do not depart from the scope of the present invention.

### 1. System Overview

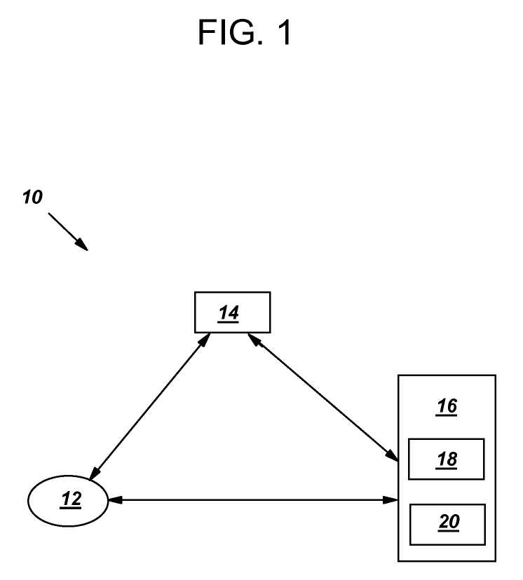

FIG. 1 shows a block diagram of a system 10 according to an embodiment. System 10 includes a virtual world user 12, a virtual world server 14 and a treatment awarding unit 16. Treatment awarding unit 16 includes a conduct monitoring unit 18 and an analysis unit 20. In operation, conduct monitoring unit 18 monitors the acts of virtual world user 12 with respect to a preferred conduct. Any method may be used in the monitoring and all are included. Based on an amount of the preferred conduct performed by virtual world user 12, analysis unit 20 determines a preferred infrastructural treatment (herein after ‘treatment’) to virtual world user 12 and controls virtual world server 14 to provide the determined preferred treatment to virtual world user 12. The preferred treatment may be provided substantially in real time as the performance of the preferred conduct, or may be accumulated and awarded periodically.

As is appreciated, a preferred conduct of virtual world user 12 may be any conduct. However, preferably, a preferred conduct is performed through a computer infrastructure and is related to virtual world participation. For example, a preferred conduct may be viewing an advertisement broadcasted with a virtual world provided by virtual world server 14. As is appreciated, virtual world server 14 and treatment awarding unit 16 and components thereof may be positioned at the same physical location or may be at different physical locations.

The interaction of system 10 components will be described herein in detail together with a computer environment.

### 2. Computer Environment

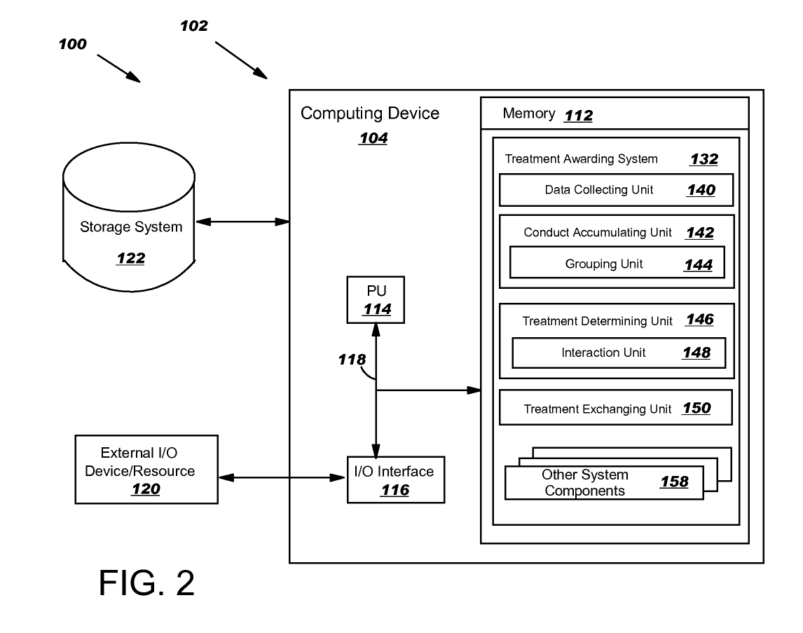

FIG. 2 shows an illustrative environment 100 for encouraging a virtual world user to perform a conduct. To this extent, environment 100 includes a computer infrastructure 102 that can perform the various processes described herein for encouraging a virtual world user 12 (FIG. 1) to perform a conduct. In particular, computer infrastructure 102 is shown including a computing device 104 that comprises a treatment awarding system 132, which enables computing device 104 to perform the process(es) described herein.

Computing device 104 is shown including a memory 112, a processing unit (PU) 114, an input/output (I/O) interface 116, and a bus 118. Further, computing device 104 is shown in communication with an external I/O device/resource 120 and a storage system 122. In general, PU 114 executes computer program code, such as treatment awarding system 132, that is stored in memory 112 and/or storage system 122. While executing computer program code, PU 114 can read and/or write data to/from memory 112, storage system 122, and/or I/O interface 116. Bus 118 provides a communications link between each of the components in computing device 104. I/O interface 116 can comprise any device that enables a user to interact with computing device 104 or any device that enables computing device 104 to communicate with one or more other computing devices. External I/O device/resource 120 can be coupled to the system either directly or through I/O interface 116.

In any event, computing device 104 can comprise any general purpose computing article of manufacture capable of executing computer program code installed thereon. However, it is understood that computing device 104 and treatment awarding system 132 are only representative of various possible equivalent computing devices that may perform the various processes of the disclosure. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the invention. For example, in an embodiment, computer infrastructure 102 comprises two or more computing devices that communicate over any type of wired and/or wireless communications link, such as a network, a shared memory, or the like, to perform the various processes of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

Treatment awarding system 132 includes a data collecting unit 140; a conduct accumulating unit 142 including a grouping unit 144; a treatment determining unit 146 including an interaction unit 148; a treatment exchanging unit 150; and other system components 158. Other system components 158 may include any now known or later developed parts of treatment awarding system 132 not individually delineated herein, but understood by those skilled in the art. As should be appreciated, components of computer infrastructure 102 and treatment awarding system 132 may be located at different physical locations or at the same physical location.

According to an embodiment, computer infrastructure 102 and treatment awarding system 132 may be used to implement, interalia, analysis unit 20 of treatment awarding unit 16 of system 10 (FIG. 1).

Inputs/outputs to computer infrastructure 102, e.g., through external I/O device/resource 120 and/or I/O interface 116, may include information communicated between and among various components of system 10, as is described herein in detail. The operation of system 10 and treatment awarding system 132 are described together herein in detail.

### 3. Operation Methodology

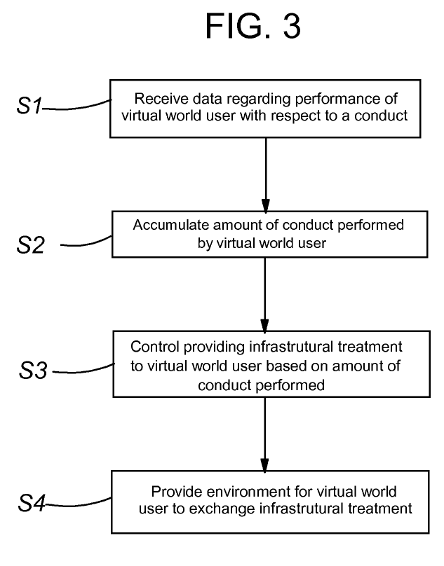

An embodiment of the operation of treatment awarding system 132 is shown in the flow diagram of FIG. 3. Referring to FIGS. 1-3, in process S1, data collecting unit 140 receives/collects data regarding the performance of a virtual world user 12 with respect to a preferred conduct, which is monitored by conduct monitoring unit 18. Here, viewing an advertisement broadcasted with a virtual world is used as an illustrative example of a preferred conduct. Any format/protocol may be used in the communication of the data, and all are included.

In process S2, conduct accumulating unit 142 accumulates an amount of the preferred conduct performed by virtual world user 12. Any method may be used to indicate the amount of the preferred conduct and all are included. For example, according to an embodiment, a score, e.g., of points, may be used to indicate the amount of the preferred conduct performed by virtual world user 12, e.g., advertisement viewing. The amount of advertisement viewing may be measured and accumulated by any method/standard, e.g., number of clicked advertisement links, and all are included. In process S2, optionally, grouping unit 144 groups the points of advertisement viewing based on the sponsors of the advertisements viewed. For example, a total score of 40 points of advertisement viewing may be grouped as 20 points of viewing advertisement of sponsor A and 20 points of viewing advertisement of sponsor B.

In process S3, treatment determining unit 146 controls virtual world server 14 to provide an infrastructural treatment to the virtual world user 12 based on the amount of the preferred conduct performed by the virtual world user 12. An infrastructural treatment includes any treatment provided by virtual world server 14 with respect to the participation of virtual world user 12 in a virtual world space. For example, the infrastructural treatment may include at least one of a virtual world parameter, a system resource allocated to virtual world user 12, a virtual world object, a virtual world tool, and an entry to a virtual world space. A virtual world parameter includes parameters of a virtual world space entered by virtual world user 12, e.g., audio stream quality, video resolution/content quality, animation speed/control/ability, virtual view quality, surrounding of the virtual world space, etc. An allocated system resource includes the system resources allocated to virtual world user 12 to be used in the virtual world participation, e.g., processing unit (PU) and memory allowance, etc. A virtual world object includes any object shown/represented in the virtual world space, e.g., appearance of an avatar, clothes, wealth of the avatar, inventory of the avatar, e.g., a car. A virtual world tool includes tools virtual world user 12 can use to, e.g., view, navigate, and modify a virtual world space, e.g., a resource pool. An entry to a virtual world space is also a preferred treatment as entry to a specific virtual world space may be limited/prioritized based on scores of virtual world users 12. As is appreciated, the above listed infrastructural treatments do not limit the scope of the invention and any infrastructural treatment provided by virtual world server 14 may be possible and is included in the disclosure.

According to an embodiment, a virtual world user 12 who performs more preferred conducts such as clicking on more advertisements, will be awarded a more preferred treatment. For example, the more preferred treatment may be more system resources allocated, a better virtual world object such as more wealth, better cars, more handsome/pretty avatar character, more powerful resource pool, higher priority in entering a virtual world space, etc. According to an embodiment, the preferred treatment will be provided substantially in real time to a virtual world user 12. For example, immediately after a virtual world user 12 clicks on an additional link of advertisement, the wealth of the avatar accumulates an additional point. Alternatively, conduct accumulating unit 142 counts advertisement viewing of a virtual world user 12, and treatment determining unit 146 determines and assigns treatments periodically. Other methods of determining and assigning treatments are also possible and included in the disclosure.

The amount of preferred conducts performed by a virtual world user 12 may be used with respect to a specific treatment, e.g., system resource, and/or a combination of multiple treatments including all treatments generally. Interaction unit 148 may communicate with virtual world user 12 regarding the providing of treatments, e.g., whether and how the preferred treatment is provided. The communication may be implemented by any method, and all are included. For example, the communication may be implemented via a graphical user interface (GUI), e.g., an interaction window. For another example, the preferred treatment may be virtually indicated in the virtual world, e.g., a car of the avatar becoming shinier.

According to an embodiment, treatment determining unit 146 may assign a score of points indicating a level of preferred treatment to virtual world user 12 based on the accumulated amount of the preferred conduct performed by virtual world user 12. This score of points may be the same or proportional to the score obtained by conduct accumulating unit 142 in process S2. Treatment determining unit 146 may determine and assign the preferred treatment itself or may communicate the score of points to virtual world user 12 to allow the virtual world user 12 to choose how to use the score in receiving preferred treatments. For example, a virtual world user 12 may choose to use the score of points for only a specific single treatment, e.g., level of beauty of the avatar, and/or for a combination of treatments aggregately. A virtual world user 12 may also choose how a preferred treatment is provided. For example, a virtual world user 12 may choose how to upgrade a car of the avatar in the virtual world.

The infrastructural treatment may be determined based on viewing an advertisement of a specific advertisement sponsor as grouping units 144 groups the points of advertisement viewing based on sponsors, and/or may be based on viewing an advertisement generally without differentiating advertisement sponsors. In the case the preferred treatment is provided based on viewing an advertisement of a specific advertisement sponsor, the provided infrastructural treatment is related to the specific advertisement sponsor. The respective infrastructural treatment may be provided or paid by the specific advertisement sponsor, and such a sponsor award may be indicated to the virtual world user 12 to, e.g., create avatar-vendor loyalty.

In process S4, treatment exchanging unit 150 provides an environment for virtual world users 12 to exchange the preferred treatment between one another. For example, a virtual world user 12 may deal with another virtual world user 12 to trade points regarding wealth for points regarding system resources. Treatment exchanging unit 150 may provide a virtual world place for them to do so, and/or may provide exchange means, e.g., virtual world currency system, to facilitate such an exchange.

Although the above description using a preferred conduct as an illustrative example, it should be appreciated that the scope of the invention is not limited by the specific example. The invention can be applied with respect to other kinds of conducts of a virtual world user 12. For example, a conduct of a virtual world user 12 not preferred by an owner of the virtual world may also be monitored and an inferior treatment, e.g., a decreased system resource, may be assigned to the virtual world user 12.

### 4. Conclusion

While shown and described herein as a method and system for encouraging a virtual world user to perform a conduct, it is understood that the disclosure further provides various alternative embodiments. For example, in an embodiment, the invention provides a program product stored on a computer-readable medium, which when executed, enables a computer infrastructure to encourage a virtual world user to perform a conduct. To this extent, the computer-readable medium includes program code, such as treatment awarding system 132 (FIG. 2), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 112 (FIG. 2) and/or storage system 122 (FIG. 2), and/or as a data signal traveling over a network (e.g., during a wired/wireless electronic distribution of the program product).

It should be appreciated that the teachings of the present invention could be offered as a business method on a subscription or fee basis. For example, a treatment awarding unit 16 (FIG. 1), a computing device 104 comprising treatment awarding system 132 (FIG. 2) could be created, maintained and/or deployed by a service provider that offers the functions described herein for customers. That is, a service provider could offer to provide a service to encourage a virtual world user to perform a conduct as described above.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for encouraging a virtual world user to perform a conduct, the method comprising:
monitoring the virtual world user with respect to the conduct; and
providing an infrastructural treatment to the virtual world user based on an amount of the conduct performed by the virtual world user.

2. The method of claim 1, wherein the infrastructural treatment providing includes assigning a score to the virtual world user based on the amount of the conduct performed by the virtual world user.

3. The method of claim 2, wherein the assigned score is with respect to at least one of: a single infrastructural treatment and a combination of multiple infrastructural treatments.

4. The method of claim 1, wherein the infrastructural treatment includes at least one of: a virtual world parameter, an allocated system resource, a virtual world object, a virtual world tool, and an entry to a virtual world space.

5. The method of claim 1, wherein the conduct includes viewing an advertisement broadcasted with a virtual world.

6. The method of claim 5, wherein the infrastructural treatment is provided based on at least one of: viewing the advertisement of a specific advertisement sponsor and viewing the advertisement generally.

7. The method of claim 6, wherein, in the case the infrastructural treatment is provided based on an amount of viewing the advertisement of the specific advertisement sponsor, the infrastructural treatment provided is related to the specific advertisement sponsor.

8. The method of claim 1, further comprising communicating with the virtual world user with respect to the providing of the infrastructural treatment.

9. The method of claim 1, further comprising providing an environment for exchanging the infrastructural treatment between virtual world users.

10. A system for encouraging a virtual world user to perform a conduct, the system comprising:
means for monitoring the virtual world user with respect to the conduct; and
means for providing an infrastructural treatment to the virtual world user based on an amount of the conduct performed by the virtual world user.

11. The system of claim 10, wherein the infrastructural treatment includes at least one of: a virtual world parameter, an allocated system resource, a virtual world object, a virtual world tool, and an entry to a virtual world space.

12. The system of claim 10, wherein the conduct includes viewing an advertisement broadcasted with a virtual world.

13. The system of claim 10, further comprising means for communicating with the virtual world user with respect to the providing of the infrastructural treatment.

14. The system of claim 10, further comprising means for providing an environment for exchanging the infrastructural treatment between virtual world users.

15. A computer program product comprising:
computer usable program code which, when executed by a computer system, enables the computer system to:
receive data regarding a monitored performance of a virtual world user with respect to a conduct; and
determine an infrastructural treatment to the virtual world user based on an amount of the conduct performed by the virtual world user.

16. The program product of claim 15, wherein the program code is further configured to enable the computer system to assign a score to the virtual world user based on the amount of the conduct performed by the virtual world user.

17. The program product of claim 15, wherein the infrastructural treatment includes at least one of: a virtual world parameter, an allocated system resource, a virtual world object, a virtual world tool, and an entry to a virtual world space.

18. The program product of claim 15, wherein the conduct includes viewing an advertisement broadcasted with a virtual world.

19. The program product of claim 15, wherein the program code is further configured to enable the computer system to communicate with the virtual world user with respect to the providing of the infrastructural treatment.

20. The program product of claim 15, wherein the program code is further configured to enable the computer system to provide an environment for exchanging the infrastructural treatment between virtual world users.

21. A method for deploying a system for encouraging a virtual world user to perform a conduct, comprising:
providing a computer infrastructure being operable to:
receive data regarding a monitored performance of the virtual world user with respect to the conduct; and
determine an infrastructural treatment to the virtual world user based on an amount of the conduct performed by the virtual world user.

22. The method of claim 21, wherein the computer infrastructure is further operable to assign a score to the virtual world user based on the amount of the conduct performed by the virtual world user.

23. The method of claim 21, wherein the infrastructural treatment includes at least one of: a virtual world parameter, an allocated system resource, a virtual world object, a virtual world tool, and an entry to a virtual world space.

24. The method of claim 21, wherein the conduct includes viewing an advertisement broadcasted with a virtual world.

25. The method of claim 21, wherein the computer infrastructure is further operable to communicate with the virtual world user with respect to the providing of the infrastructural treatment.

26. The method of claim 21, wherein the computer infrastructure is further operable to provide an environment for exchanging the infrastructural treatment between virtual world users.
